(19) United States
(12) Patent Application Publication
(10) Pub. No.: US 2019/0063633 A1
(43) Pub. Date: Feb. 28, 2019

(54) OIL PRESSURE CONTROL DEVICE

(71) Applicant: NIDEC TOSOK CORPORATION, Kanagawa (JP)

(72) Inventor: Saori NUIYA, Kanagawa (JP)

(73) Assignee: NIDEC TOSOK CORPORATION, Kanagawa (JP)

(21) Appl. No.: 16/114,261

(22) Filed: Aug. 28, 2018

(30) Foreign Application Priority Data
Aug. 29, 2017 (JP) 2017-163929

(51) Int. Cl. F16K 31/06; F01L 1/344; F16K 11/07; F16H 61/06

(52) U.S. Cl. CPC F16K 31/0613; F01L 1/3442; F01L 2001/34426; F16H 61/067; F16K 11/0716

(57) ABSTRACT

An oil pressure control device is provided with a valve member including: a cylindrical sleeve having a first end part and a second end part opposite thereto; a valve body arranged on the side of the second end part; a movable member arranged in the hollow part on the side of the first end part, housed to be movable along the hollow part, having a pressure receiving surface on the side of the first end part of the cylindrical sleeve to receive an oil pressure, and having a contact part on the side of the second end part to contact the valve body according to the oil pressure on the pressure receiving surface; and a detent member arranged between the valve body and the second end part to limit movement of the valve body towards the side of the second end part within a predetermined range.

### CROSS-REFERENCE TO RELATED APPLICATION

This application claims the priority of Japan patent application serial no. 2017-163929, filed on Aug. 29, 2017. The entirety of the above-mentioned patent application is hereby incorporated by reference herein and made a part of this specification.

### BACKGROUND

### Technical Field

The disclosure relates to an oil pressure control device.

### Description of Related Art

An oil pressure control device having a valve member such as a ball valve or the like is widely used, for example, in an oil pressure supply mechanism of a vehicle. The ball valve is constructed by placing a ball as a valve body in a hollow sleeve provided with an open end. For example, Japanese Laid-open No. 2016-194356 discloses an oil pressure supply mechanism including an accumulator, which is applied to a vehicle that performs automatic stop control of an engine. The oil pressure supply mechanism performs control such that hydraulic oil flows into the accumulator and accumulates via the open end of the ball valve until a predetermined stop condition is satisfied and the engine is stopped. In addition, when the predetermined stop condition is satisfied, the oil pressure supply mechanism described in Japanese Laid-open Publication No. 2016-194356 performs control to push up the ball to open the valve of the ball valve, release the oil pressure accumulated in the accumulator via the open end of the ball valve, and apply pressure to the forward clutch.

However, in the conventional oil pressure control device, the valve member is housed in a case of a stacked structure in which an oil passage is provided corresponding to the port of the valve member. In other words, a recess is provided in each of opposed portions of the upper part and the lower part of the case, and a valve member is housed in a housing space formed by the recesses in the upper part and the lower part of the case. In the assembly and manufacture of the oil pressure control device, the valve member is inserted into the recess of the lower part of the case, and then the upper part of the case is stacked to cover the lower part of the case such that the valve member is housed in the recess of the upper part of the case. At this time, the ball may fall off from the open end of the hollow sleeve of the valve member. Also, during the operation of the oil pressure control device, when the ball of the ball valve is pushed up, the ball collides with the inner wall of the oil passage of the upper part of the case from the open end of the hollow sleeve, and contaminants may occur.

### SUMMARY

According to an exemplary embodiment of the disclosure, an oil pressure control device includes: a first body part having a first oil passage inside and having a first recess communicating with the first oil passage from a first opening on an outer surface; a second body part having a second oil passage inside and having a second recess communicating with the second oil passage from a second opening on an outer surface; and a columnar valve member. The first body part and the second body part are arranged such that the first opening and the second opening are opposed to each other and the valve member is housed in a housing space formed by the first recess and the second recess. The valve member includes: a cylindrical sleeve having a first end part which is an end part having a third opening communicating with the first oil passage, a second end part which is an end part having a fourth opening communicating with the second oil passage opposite to the first end part, and a hollow part between the first end part and the second end part; a valve body arranged in the hollow part on a side of the second end part to open and close a third oil passage forming the hollow part on the side of the second end part; a movable member arranged in the hollow part on a side of the first end part and housed to be movable along the hollow part, and having a pressure receiving surface on the side of the first end part to receive an oil pressure from the first oil passage and having a contact part on the side of the second end part to contact the valve body according to the oil pressure on the pressure receiving surface; and a detent member arranged between the valve body and the second end part to limit movement of the valve body towards the side of the second end part within a predetermined range.

The above and other elements, features, steps, characteristics and advantages of the disclosure will become more apparent from the following detailed description of the exemplary embodiments with reference to the attached drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an exploded perspective view of an oil pressure control device according to an embodiment.

FIG. 2 is a sectional view of the oil pressure control device of the embodiment.

FIG. 3 is a perspective view of a valve member.

FIG. 4 is a perspective view of the valve member.

FIG. 5 is an exploded perspective view of a part of the components of the valve member.

FIG. 6 is a partially enlarged exploded perspective view of a part of the components of the valve member.

FIG. 7 is a top view of the valve member included in the oil pressure control device of the embodiment.

FIG. 8a is a diagram for explaining a first state of input/output ports of the valve member.

FIG. 8b is a diagram for explaining a second state of the input/output ports of the valve member.

FIG. 9a is a diagram illustrating a valve member according to a modified example.

FIG. 9b is a sectional view of the valve member shown in FIG. 9a.

FIG. 10 is a diagram illustrating a valve member according to another modified example.

### DESCRIPTION OF THE EMBODIMENTS

The disclosure prevents the valve body of the valve member from falling off during manufacture of the oil pressure control device including the valve member and suppresses the occurrence of contaminants due to the operation of the oil pressure control device.

One embodiment of an oil pressure control device of the disclosure will be described below. Hereinafter, as an embodiment of the oil pressure control device of the disclosure, reference will be made to the case where the oil pressure control device of the present embodiment is incorporated in an oil pressure supply mechanism including an accumulator and applied to a vehicle that performs automatic stop control of the engine, but the use of the oil pressure control device of the disclosure is not limited thereto.

### (1) Configuration of an Oil Pressure Control Device 1 of the Present Embodiment

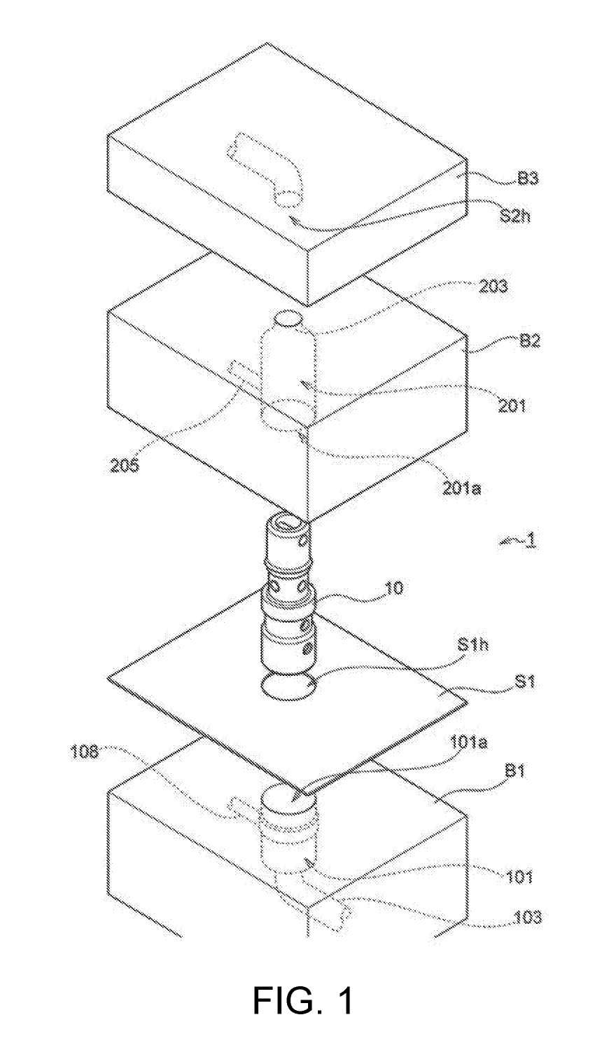

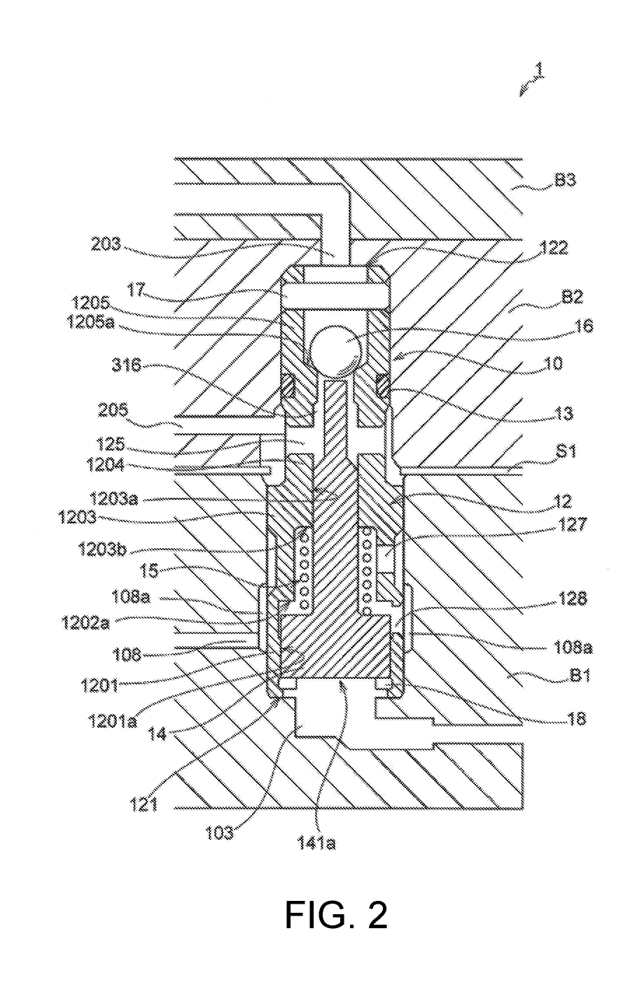

Hereinafter, the configuration of the oil pressure control device 1 of the present embodiment will be described with reference to FIG. 1 and FIG. 2. FIG. 1 is an exploded perspective view of the oil pressure control device 1 of the present embodiment. FIG. 2 is a sectional view of the oil pressure control device 1 of the present embodiment.

As shown in FIG. 1 and FIG. 2, the oil pressure control device 1 of the present embodiment is formed by stacking a plurality of body parts (a first body part B1, a second body part B2, and a third body part B3) as a whole, and a columnar valve member 10 is incorporated in the plurality of body parts. That is, the oil pressure control device 1 includes the first body part B1, the second body part B2, the third body part B3, and the columnar valve member 10. An oil passage is provided in the plurality of body parts B1 to B3, and the oil passage leads to the input/output ports of the valve member 10. As shown in FIG. 2, the valve member 10 is a ball valve including a spherical valve body 16. That is, the valve member 10 is configured to communicate or disconnect hydraulic oil flowing through the plurality of body parts B1 to B3 in the valve member 10 by the opening or blocking operation of the valve body 16.

More specifically, in the oil pressure control device 1, the first body part B1 of the lower layer, the second body part B2 of the upper layer, and the third body part B3 of the uppermost layer have a stacked structure in FIG. 2. Each of the body parts is a die-cast member of a metal such as aluminum, for example. A separate plate S1 is provided between the first body part B1 and the second body part B2. The separate plate S1 is a flat plate of iron, for example, and provides a sealing function between the adjacent body parts. In the separate plate S1, a circular hole S1h is provided for arranging the valve member 10. A separate plate is not provided between the second body part B2 and the third body part B3, but a separate plate may be provided to provide a further sealing function. In FIG. 1, the shapes of the first body part B1, the second body part B2, and the third body part B3 are rectangular parallelepipeds but are not limited thereto. The shapes of the body parts may be appropriately modified according to the appearance shape required for the oil pressure control device 1.

As shown in FIG. 1, the first body part B1 includes an oil passage 103 therein and a first recess 101 communicating with the oil passage 103 from a first opening 101a on the outer surface. The second body part B2 includes an oil passage 203 therein and a second recess 201 communicating with the oil passage 203 from a second opening 201a on the outer surface. The oil passage 103 is an example of a first oil passage, and the oil passage 203 is an example of a second oil passage.

In a state in which the body parts are stacked and assembled, the first body part B1 and the second body part B2 are arranged such that the first opening 101a and the second opening 201a are opposed to each other and the valve member 10 is housed in a housing space formed by the first recess 101 and the second recess 201. That is, the circular first opening 101a, the circular second opening 201a, and the circular hole S1h of the separate plate S1 are aligned and overlap with each other in the vertical direction in FIG. 2. In this state, the valve member 10 is housed in the columnar housing space formed by the first recess 101, the circular hole S1h, and the second recess 201. The diameter of the first opening 101a and the diameter of the second opening 201a are substantially the same as the outer diameters of corresponding portions (i.e., a first cylindrical part 1201 and a third cylindrical part 1203 to be described below) of the columnar valve member 10. In order not to interfere with the first cylindrical part 1201 and the third cylindrical part 1203 of the valve member 10, the circular hole S1h of the separate plate S1 has a diameter slightly larger than the outer diameters of the first cylindrical part 1201 and the third cylindrical part 1203.

### (2) Configuration of the Valve Member 10

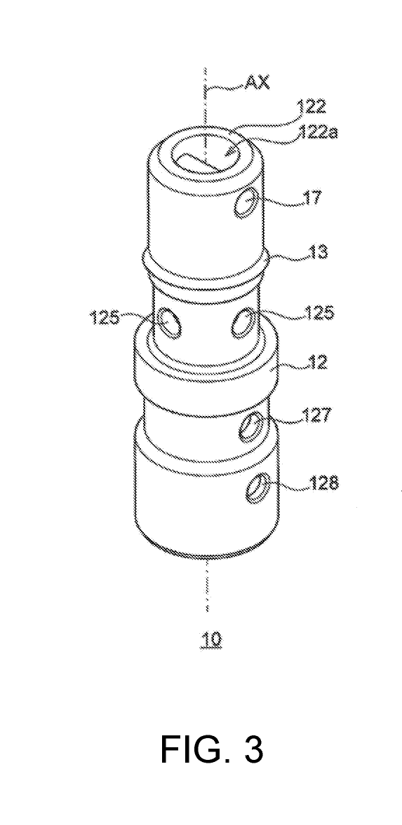

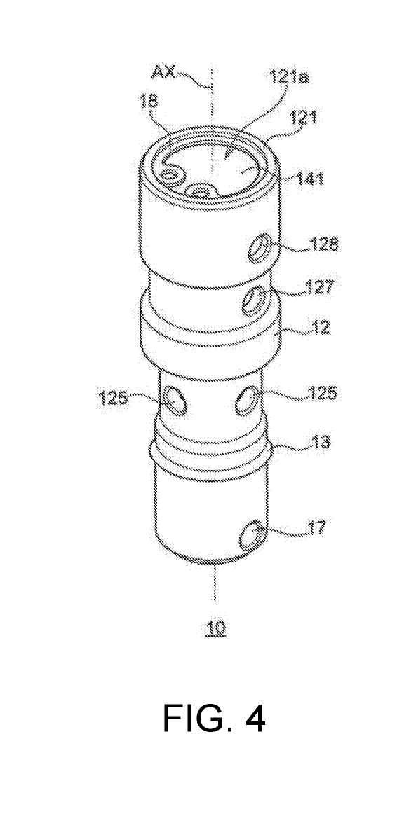

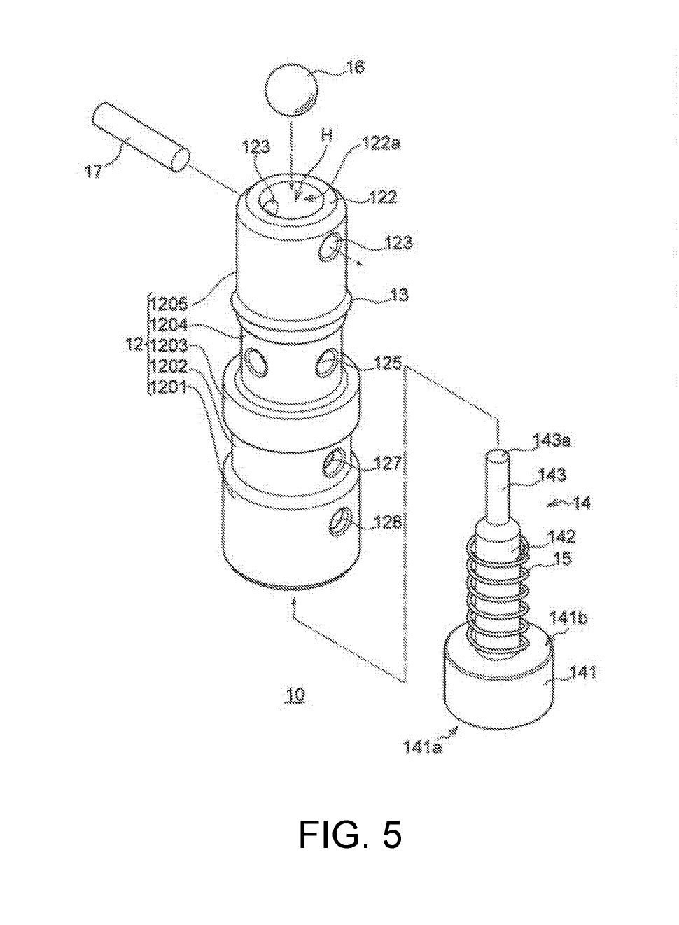

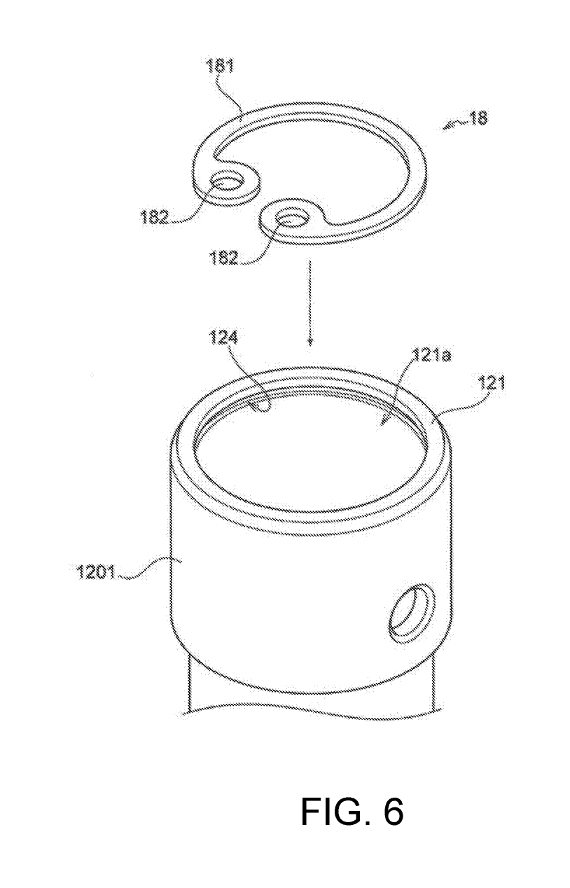

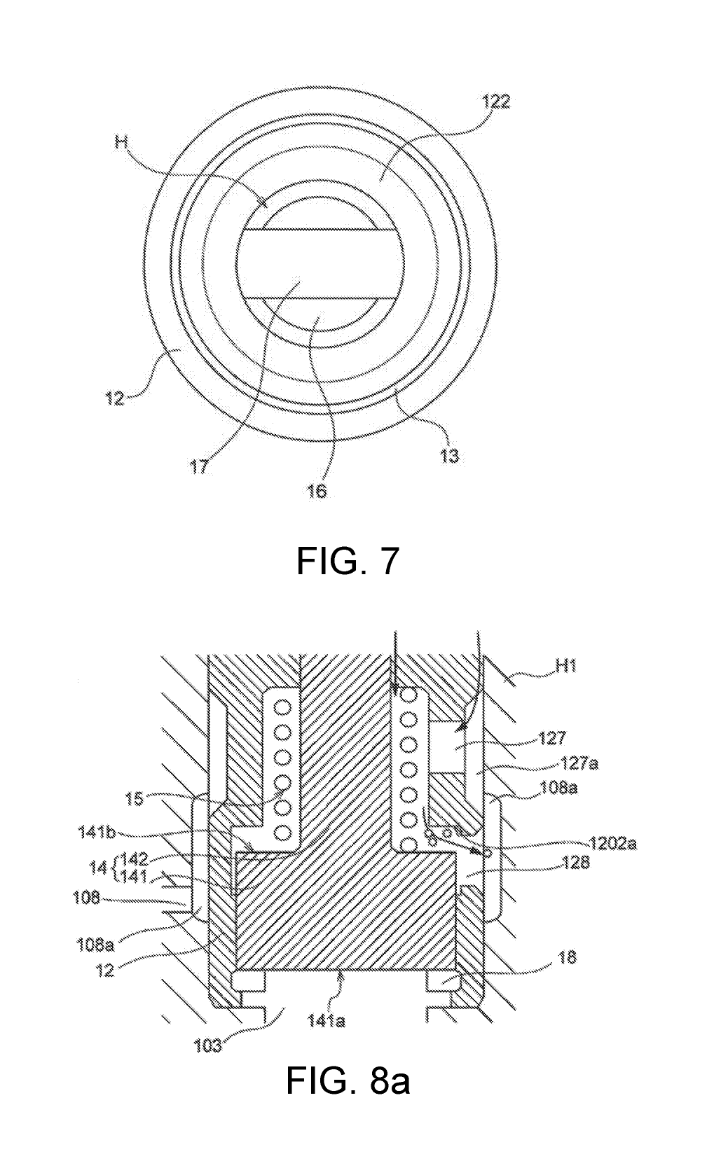

Next, the configuration of the valve member 10 incorporated in the oil pressure control device 1 of the present embodiment will be described with reference to FIGS. 3 to 7. FIG. 3 is a perspective view of the valve member 10. FIG. 4 is a perspective view of the valve member 10 as viewed from a viewpoint different from FIG. 3. FIG. 5 is an exploded perspective view of a part of the components of the valve member 10 and is a view as viewed from the same viewpoint as FIG. 3. FIG. 6 is a partially enlarged exploded perspective view of a part of the components of the valve member 10 and is a view as viewed from the same viewpoint as FIG. 4. FIG. 7 is a top view of the valve member 10.

As shown in FIGS. 3 and 4, the valve member 10 has a cylindrical shape as a whole, and a plurality of input/output ports 125, 127, and 128 are provided. As shown in FIG. 2, the input/output port 125 communicates with an oil passage 205 of the second body part B2, and the input/output port 128 communicates with an oil passage 108 of the first body part B1. In the following description, the axial direction means the direction along a central axis AX in the longitudinal direction of the valve member 10. The axial direction is the same as the vertical direction in FIG. 2. The central axis AX is the same as the central axis in the longitudinal direction of a cylindrical sleeve 12 to be described below. The circumferential direction of the inner circumferential wall of the cylindrical sleeve 12 means the direction along the inner circumferential wall plane of the cylindrical sleeve 12 on a virtual plane orthogonal to the central axis AX. The circumferential direction of the outer circumferential wall of the cylindrical sleeve 12 means the direction along the outer circumferential wall plane of the cylindrical sleeve 12 on the virtual plane orthogonal to the central axis AX.

As shown in FIGS. 5 and 6, the valve member 10 includes the cylindrical sleeve 12, an O-ring 13, a movable member 14, a coil spring 15, the valve body 16, a pin 17 (which is an example of a detent member), and a C-shaped ring 18. The cylindrical sleeve 12 includes a first end part 121, which is an end part having a third opening 121a communicating with the oil passage 103, and a second end part 122, which is an end part having a fourth opening 122a communicating with the oil passage 203 opposite to the first end part 121, and includes a hollow part H between the first end part 121 and the second end part 122.

As shown in FIG. 5, the cylindrical sleeve 12 includes the first cylindrical part 1201, a second cylindrical part 1202, the third cylindrical part 1203, a fourth cylindrical part 1204, and a fifth cylindrical part 1205. The outer diameters of the first cylindrical part 1201 and the third cylindrical part 1203 are larger than the outer diameters of the second cylindrical part 1202, the fourth cylindrical part 1204, and the fifth cylindrical part 1205.

The first cylindrical part 1201 is provided with the input/output port 128 for communicating the hollow part H and the oil passage 108 (see FIG. 2). The end part of the first cylindrical part 1201 is the first end part 121 of the cylindrical sleeve 12. The inner diameter of the first cylindrical part 1201 is substantially equal to the outer diameter of a first sliding part 141, so that when the movable member 14 moves in the hollow part H, the first sliding part 141 of the movable member 14 slides on an inner circumferential wall 1201a (see FIG. 2) of the first cylindrical part 1201. The second cylindrical part 1202 is provided with the input/output port 127 communicating with the hollow part H. The second cylindrical part 1202 is provided with a stopper surface 1202a (see FIG. 2) at a position opposed to a spring seat surface 141b (to be described below) of the movable member 14 in the axial direction.

The inner diameter of the third cylindrical part 1203 is substantially equal to the outer diameter of a second sliding part 142, so that when the movable member 14 moves in the hollow part H, the second sliding part 142 of the movable member 14 slides on an inner circumferential wall 1203a (see FIG. 2) of the third cylindrical part 1203. As shown in FIG. 2, the third cylindrical part 1203 is provided with a spring seat surface 1203b at a position opposed to the spring seat surface 141b (see FIG. 5) of the movable member 14 in the axial direction.

The fourth cylindrical part 1204 is provided with the input/output port 125 (at four positions in the circumferential direction) for communicating the hollow part H and the oil passage 205 (see FIG. 2). The fifth cylindrical part 1205 is provided with a through hole 123 (at two positions in the circumferential direction) through which the pin 17 penetrates. The end part of the fifth cylindrical part 1205 is the second end part 122 of the cylindrical sleeve 12. As shown in FIG. 2, the fifth cylindrical part 1205 is provided with a tapered valve seat surface 1205a in the hollow part H. A groove for arranging the O-ring 13 is provided in the circumferential direction of the outer circumferential wall of the fifth cylindrical part 1205. As shown in FIG. 2, the O-ring 13 is a member that seals between the oil passage 205 and the oil passage 203 of the second body part B2.

The movable member 14 is arranged in the hollow part H on the side of the first end part 121 and is housed to be movable along the hollow part H. The movable member 14 has a pressure receiving surface 141a on the side of the first end part 121 that receives the oil pressure from the oil passage 103, and a contact part 143a on the side of the second end part 122 that can contact the valve body 16 according to the oil pressure on the pressure receiving surface 141a.

As shown in FIG. 5, the movable member 14 has the first sliding part 141, which is a large-diameter column part extending from one side to the other side along the axial direction, the second sliding part 142, which is a column part having a diameter smaller than that of the first sliding part 141, and a front end part 143, which is a column part having a diameter smaller than that of the second sliding part 142.

The bottom surface of the first sliding part 141 is the pressure receiving surface 141a. Since the pressure receiving surface 141a has a relatively large diameter, the oil pressure from the oil passage 103 can be converted into a force that efficiently moves the movable member 14 in the axial direction. When the movable member 14 moves in the axial direction, the first sliding part 141 slides on the inner circumferential wall 1201a of the first cylindrical part 1201 and the second sliding part 142 slides on the inner circumferential wall 1203a of the third cylindrical part 1203. The upper surface of the front end part 143 is the contact part 143a. As shown in FIG. 2, the outer diameter of the front end part 143 is determined such that an oil passage 316 can be provided between the inner circumferential walls of the fourth cylindrical part 1204 and the fifth cylindrical part 1205. The oil passage 316 is an example of a third oil passage. The position of the contact part 143a of the front end part 143 in the axial direction is determined such that the contact part 143a does not contact the valve body 16 when the oil pressure received by the pressure receiving surface 141a from the oil passage 103 is low.

The coil spring 15 is arranged between the spring seat surface 141b, which is the upper surface of the first sliding part 141 of the movable member 14, and the spring seat surface 1203b (see FIG. 2) of the third cylindrical part 1203. Serving as an urging member, the coil spring 15 urges the movable member 14 towards the third opening 121a of the cylindrical sleeve 12 in the hollow part H of the cylindrical sleeve 12. Due to the urging force of the coil spring 15, when the oil pressure received by the pressure receiving surface 141a from the oil passage 103 is low, no force for moving the movable member 14 against the urging force is generated.

The valve body 16 is arranged on the side of the second end part 122 in the hollow part H and opens and closes the oil passage 316 (see FIG. 2) that forms the hollow part H on the side of the second end part 122. In the example of the present embodiment, the valve body 16 is spherical but is not limited thereto, and any form may be used as long as the oil passage 316 can be opened and closed. For example, as alternatives to the valve body 16, it may be a valve body having an elliptical cross section, or a valve body in a bullet-like form (a shape with a tapered end).

As shown in FIG. 2, the pin 17 is arranged between the valve body 16 and the second end part 122 and limits the movement of the valve body 16 towards the side of the second end part 122 within a predetermined range. In the example of the present embodiment, the pin 17 is a columnar pin but is not limited thereto. As shown in FIG. 5, the two through holes 123 are provided in the circumferential wall of the fifth cylindrical part 1205 of the cylindrical sleeve 12. The pin 17 is supported by the two through holes 123 and is arranged such that it crosses the hollow part H of the cylindrical sleeve 12. Further, as shown in FIG. 7, the pin 17 is mounted to the cylindrical sleeve 12 such that it overlaps with the valve body 16 when the valve member 10 is viewed from the second end part 122 towards the first end part 121 (i.e., in the axial direction). Therefore, the movement of the valve body 16 in the axial direction from the valve seat surface 1205a is limited such that the valve body 16 moves until the apex of the spherical valve body 16 in FIG. 2 contacts the front surface of the pin 17.

The pin 17 may be rotatably supported on the circumferential wall of the cylindrical sleeve 12. In that case, the position on the front surface of the pin 17 that the valve body 16 contacts when the valve member 10 is in operation does not concentrate at a specific position, and stress concentration on the pin 17 is avoided.

The C-shaped ring 18 is arranged between the pressure receiving surface 141a of the movable member 14 and the first end part 121 having the third opening 121a, and limits the movement of the movable member 14 towards the side of the first end part 121 within a predetermined range. As shown in FIG. 6, a groove 124 is provided in the circumferential direction on the inner circumferential wall of the first cylindrical part 1201 of the cylindrical sleeve 12, i.e., on the inner circumferential wall at a position close to the first end part 121. The C-shaped ring 18 is reduced in diameter and inserted into the groove 124, and in the groove 124, it is kept at the bottom surface position of the groove 124 by an urging force acting in the diameter expanding direction. The C-shaped ring 18 is partially supported in the groove 124 and partially contacts a part of the circumference of the pressure receiving surface 141a.

As shown in FIG. 6, the C-shaped ring 18 includes a C-shaped curved part 181 and jig insertion holes 182 provided at both ends of the curved part 181. That is, both end parts of the C-shaped ring 18 are provided with the jig insertion holes 182 for reducing the diameter from the inner diameter of the cylindrical sleeve 12 at the position of the groove 124. By inserting a jig into the jig insertion hole 182 to reduce the diameter of the C-shaped ring 18, the workability at the time of inserting the C-shaped ring 18 into the groove 124 becomes favorable. Where the jig is not used, the jig insertion hole 182 may not be provided. A part of the C-shaped ring 18 protrudes inwards from the groove 124 after being inserted into the groove 124 and supports a part of the pressure receiving surface 141a of the cylindrical sleeve 12 in the axial direction. The protrusion amount may be appropriately set as long as it can support the cylindrical sleeve 12 in the axial direction. Since the thickness of the C-shaped ring 18 in the axial direction may be small, the C-shaped ring 18 is excellent in space efficiency in the axial direction and the pressure receiving surface 141a doesn't need to be sacrificed too much.

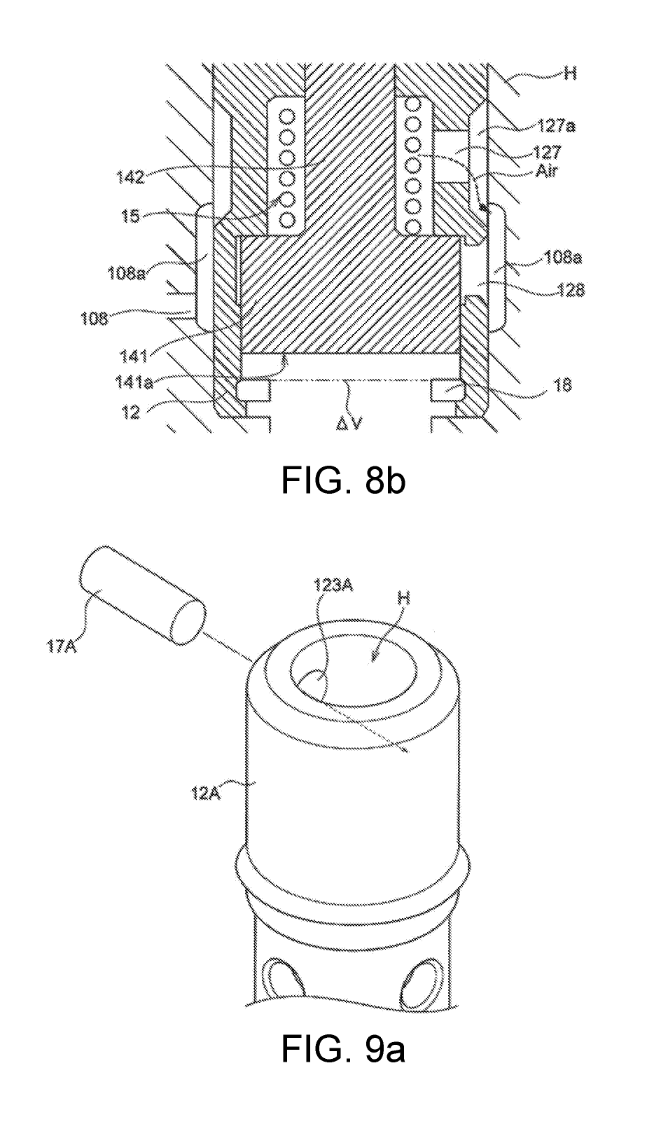

Next, with reference to FIG. 8a and FIG. 8b, the input/output ports 127 and 128 will be described below. FIG. 8a and FIG. 8b are diagrams for explaining the input/output ports of the valve member 10, wherein FIG. 8a is a partial sectional view of the oil pressure control device 1 at the time when the oil passage 103 is under a low pressure, and FIG. 8b is a partial sectional view of the oil pressure control device 1 at the time when the oil passage 103 is under a high pressure. The oil passage 108 of the first body part B1 is a discharge passage through which the hydraulic oil in the valve member 10 is discharged. As shown in the drawing, at the end part of the oil passage 108 communicating with the input/output port 128 of the valve member 10, a groove 108a is provided in the circumferential direction of the outer circumferential wall of the cylindrical sleeve 12. The oil passage 108 is on the side opposite to the input/output port 128 in the groove 108a in the circumferential direction and is connected to one end side in the axial direction. The groove 108a of the oil passage 108 is provided for the function of effectively discharging the contaminants in the valve member 10 and the function of smoothing the operation of the valve member 10.

The function of effectively discharging the contaminants in the valve member 10 is as follows. When the oil passage 103 is under a high pressure, the pressure applied to the pressure receiving surface 141a is high, so the movable member 14 is separated from the C-shaped ring 18 and the spring seat surface 141b is brought into contact with the stopper surface 1202a. Therefore, the contaminants inside the valve member 10 are accumulated on the spring seat surface 141b by gravity. When the oil passage 103 is under a low pressure, the pressure applied to the pressure receiving surface 141a is low, so the movable member 14 is in contact with the C-shaped ring 18. At this time, the hydraulic oil flowing downwards from the gap between the inner circumferential wall of the cylindrical sleeve 12 and the second sliding part 142 and the gap between the outer circumferential wall of the cylindrical sleeve 12 and the first body part B1 passes between the spring seat surface 141b of the first sliding part 141 and the stopper surface 1202a of the cylindrical sleeve 12 and is led to the groove 108a of the oil passage 108. Therefore, the contaminants accumulated on the spring seat surface 141b move along the groove 108a along with the hydraulic oil in the circumferential direction and are discharged from the oil passage 108 connected to one side in the axial direction of the groove 108a without staying in the groove 108a.

The function of smoothing the operation of the valve member 10 is as follows. When the pressure of the oil passage 103 changes from a low pressure to a high pressure, the movable member 14 is pushed up to an extent corresponding to a predetermined volume (ΔV in FIG. 8b) inside the cylindrical sleeve 12. Therefore, if a mechanism for relieving pressure is not provided, the inside of the cylindrical sleeve 12 will be under a high pressure, which impedes the smooth movement of the movable member 14. In contrast, in the present embodiment, as shown in FIGS. 8a and 8b, a port end part 127a of the input/output port 127 has a shape that expands as it extends from the hollow part H of the cylindrical sleeve 12 towards the first body part B1, and the port end part 127a communicates with the groove 108a. Therefore, when the pressure of the oil passage 103 changes from a low pressure to a high pressure, as indicated by a dotted line in FIG. 8b, air inside the cylindrical sleeve 12 moves from the port end part 127a of the input/output port 127 to the groove 108a to suppress pressure inside the cylindrical sleeve 12 to become high pressure. It is favorable that the volume of the groove 108a is larger than ΔV mentioned above.

### (3) Operation of the Valve Member 10 in the Oil Pressure Control Device 1 of the Present Embodiment

Next, the operation of the valve member 10 in the oil pressure control device 1 of the present embodiment will be described. As described above, the oil pressure control device 1 of the present embodiment is incorporated in an oil pressure supply mechanism including an accumulator and applied to a vehicle that performs automatic stop control of the engine.

In the oil pressure supply mechanism, an operation of accumulating pressure in the accumulator (not shown) is performed until a predetermined stop condition is satisfied and the engine is stopped. The oil passage 203 of the oil pressure control device 1 communicates with the accumulator. When the operation of accumulating pressure in the accumulator is performed, the pressure of the accumulator is set to be lower than the oil passage 205. Therefore, the pressure of the hydraulic oil flowing through the oil passage 205 pushes up the valve body 16 via the oil passage 316, and the hydraulic oil flows into the accumulator via the fourth opening 122a and the oil passage 203 and pressure is accumulated.

Next, when the predetermined stop condition is satisfied, the pressure of the oil passage 103 of the oil pressure control device 1 is controlled to rise. Therefore, due to the oil pressure received by the pressure receiving surface 141a of the movable member 14, the movable member 14 of the valve member 10 is pushed up against the urging force of the coil spring 15, and the contact part 143a of the movable member 14 pushes up the valve body 16 to open the oil passage 316. As a result, the hydraulic oil accumulated in the accumulator flows backwards to the oil passage 205 via the oil passage 203, the fourth opening 122a, the oil passage 316, and the input/output port 125. The oil pressure of the hydraulic oil accumulated in the accumulator communicates with a forward clutch via an oil passage (not shown) and makes it possible to smoothly start the vehicle. In the present embodiment, when the contact part 143a of the movable member 14 pushes up the valve body 16, since the pin 17 is arranged above the valve body 16 as shown in FIG. 2, collision of the valve body 16 with the second body part B2 is avoided. Therefore, occurrence of contaminants due to the operation of the oil pressure control device 1 can be suppressed.

### (4) Assembling Method of the Oil Pressure Control Device 1 of the Present Embodiment

Next, an assembling method of the oil pressure control device 1 of the present embodiment will be described with reference to FIGS. 1, 5, and 6. First, in the assembly of the valve member 10, in FIG. 5, the O-ring 13 is attached to the cylindrical sleeve 12, the valve body 16 is housed in the hollow part H of the cylindrical sleeve 12, and then the pin 17 is inserted into the through holes 123. Next, the cylindrical sleeve 12 including the valve body 16 is turned over, and the cylindrical sleeve 12 is arranged such that the first end part 121 faces upwards as shown in FIG. 6. The movable member 14 attached with the coil spring 15 is inserted into the hollow part H of the cylindrical sleeve 12 via the third opening 121a of the first end part 121. Finally, when the C-shaped ring 18 is mounted to the groove 124 with its diameter reduced by using a jig, the valve member 10 is completed.

Next, as shown in FIG. 1, the first body part B1 is arranged on a plane and the separate plate S1 is arranged on the upper surface of the first body part B1 with the circular hole S1h aligned with the first opening 101a. Next, the valve member 10 is inserted into the first recess 101 starting from the side of the first end part 121 via the circular hole S1h and the first opening 101a. Thereafter, the second body part B2 is arranged on the separate plate S1 such that the side of the second end part 122 of the valve member 10 is inserted into the second recess 201. Finally, by arranging the third body part B3 on the second body part B2 and connecting the first body part B1, the second body part B2, and the third body part B3 with a fastening means (not shown), the oil pressure control device 1 is completed.

In the valve member 10 of the present embodiment, since the pin 17 is arranged above the valve body 16, in the process of assembling the oil pressure control device 1, the pin 17 functions as a stopper of the valve body 16 and the valve body 16 is prevented from falling off from the fourth opening 122a of the second end part 122 of the cylindrical sleeve 12. Also, in the valve member 10 of the present embodiment, since the C-shaped ring 18 is arranged between the pressure receiving surface 141a of the movable member 14 and the first end part 121, in the process of assembling the oil pressure control device 1, the movable member 14 is prevented from falling off from the third opening 121a of the first end part 121.

As described above, according to the oil pressure control device 1 of the present embodiment, the pin 17 is provided to limit the movement of the valve member 10 towards the side of the second end part 122 within a predetermined range. Therefore, it is possible to prevent the valve body 16 of the valve member 10 from falling off during manufacture of the oil pressure control device 1 including the valve member 10 and suppress occurrence of contaminants due to the operation of the oil pressure control device 1. Also, according to the oil pressure control device 1 of the present embodiment, by arranging the C-shaped ring 18, it is possible to prevent the movable member 14 of the valve member 10 from falling off during manufacture of the oil pressure control device 1 including the valve member 10.

Although embodiments of the oil pressure control device of the disclosure have been described above, the disclosure is not limited to the embodiments above. In addition, various improvements and modifications can be made to the embodiments above within the scope without departing from the gist of the disclosure.

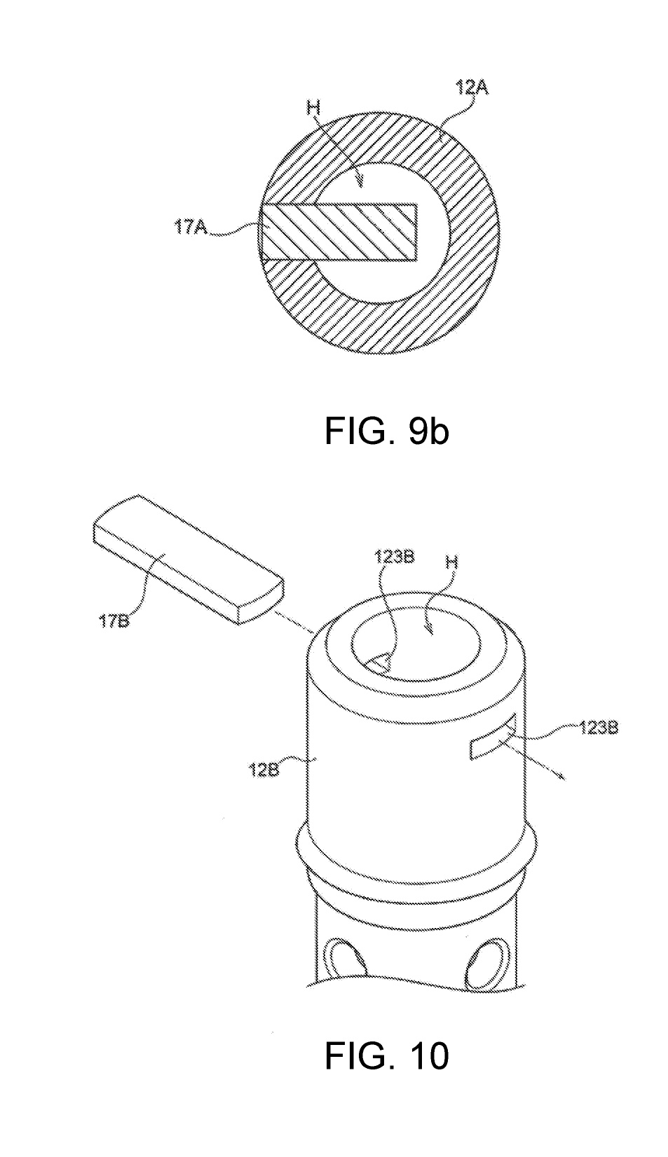

For example, in the embodiment above, as shown in FIG. 5, the pin 17 as a detent member is supported by the two through holes 123 and is mounted to cross the hollow part H of the cylindrical sleeve 12, but the disclosure is not limited thereto. As long as the detent member is mounted to the cylindrical sleeve 12 to overlap with the valve body 16 as viewed from the upper surface of the valve member 10, two through holes 123 are not necessarily required. FIG. 9a is a perspective view of a pin 17A and a cylindrical sleeve 12A according to a modified example, similar to FIG. 5, showing a mode of inserting the pin 17A into the cylindrical sleeve 12A. FIG. 9b is a cross section of the pin 17A taken along a plane orthogonal to the axial direction when the pin 17A is inserted into the cylindrical sleeve 12A. In the modified example shown in FIGS. 9a and 9b, only one through hole 123A is provided in the cylindrical sleeve 12A, and the pin 17A inserted from the through hole 123A does not completely cross the hollow part H of the cylindrical sleeve 12A. Even in this case, since the pin 17A is mounted to the cylindrical sleeve 12A to overlap with the valve body 16 as viewed from the upper surface of the valve member 10, the pin 17A exhibits the same function and effect as the pin 17 of the present embodiment.

In the embodiment above, the case where the pin 17 serving as the detent member is a columnar pin has been described as shown in FIG. 5, but the disclosure is not limited thereto. The pin is not necessarily columnar. FIG. 10 shows a modified example to which a non-columnar pin 17B is applied. In FIG. 10, the pin 17B having a rectangular cross section is inserted and mounted through two through holes 123B of a cylindrical sleeve 12B. In the state of being mounted to the cylindrical sleeve 12B, the pin 17B has a flat surface opposed to the valve body 16 in the hollow part H. With the pin 17B, there is an advantage that it is possible to prevent the valve body 16 from falling off without taking up as much space in the axial direction as compared with the columnar pin 17.

Features of the above-described exemplary embodiments and the modifications thereof may be combined appropriately as long as no conflict arises.

While the exemplary embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An oil pressure control device, comprising:
a first body part having a first oil passage inside and having a first recess communicating with the first oil passage from a first opening on an outer surface;
a second body part having a second oil passage inside and having a second recess communicating with the second oil passage from a second opening on an outer surface; and
a columnar valve member,
wherein the first body part and the second body part are arranged such that the first opening and the second opening are opposed to each other and the valve member is housed in a housing space formed by the first recess and the second recess,
wherein the valve member comprises:
a cylindrical sleeve comprising a first end part which is an end part having a third opening communicating with the first oil passage, a second end part which is an end part having a fourth opening communicating with the second oil passage opposite to the first end part, and a hollow part between the first end part and the second end part;
a valve body arranged in the hollow part on a side of the second end part to open and close a third oil passage forming the hollow part on the side of the second end part;
a movable member arranged in the hollow part on a side of the first end part and housed to be movable along the hollow part, and having a pressure receiving surface on the side of the first end part to receive an oil pressure from the first oil passage and having a contact part on the side of the second end part to contact the valve body according to the oil pressure on the pressure receiving surface; and
a detent member arranged between the valve body and the second end part to limit movement of the valve body towards the side of the second end part within a predetermined range.

2. The oil pressure control device according to claim 1, wherein the detent member is mounted to the cylindrical sleeve so as to overlap with the valve body when the valve member is viewed in a direction from the second end part to the first end part.

3. The oil pressure control device according to claim 1, wherein a circumferential wall of the cylindrical sleeve is provided with two holes, and the detent member is supported by the two holes and is arranged so as to cross the hollow part of the cylindrical sleeve.

4. The oil pressure control device according to claim 2, wherein a circumferential wall of the cylindrical sleeve is provided with two holes, and the detent member is supported by the two holes and is arranged so as to cross the hollow part of the cylindrical sleeve.

5. The oil pressure control device according to claim 2, wherein the detent member is a columnar pin.

6. The oil pressure control device according to claim 4, wherein the columnar pin is rotatably supported by the circumferential wall of the cylindrical sleeve.

7. The oil pressure control device according to claim 1, wherein the detent member has a flat surface opposed to the valve body.

8. The oil pressure control device according to claim 2, wherein the detent member has a flat surface opposed to the valve body.

9. The oil pressure control device according to claim 3, wherein the detent member has a flat surface opposed to the valve bod
